(19) United States
(12) Patent Application Publication
(10) Pub. No.: US 2025/0031903 A1
(43) Pub. Date: Jan. 30, 2025

(54) GRAVITY FED SMOKER

(71) Applicant: W.C. BRADLEY CO., Columbus, GA (US)

(72) Inventors: RAMIN KHOSRAVI RAHMANI, Columbus, GA (US); WILLIAM DIXON, Columbus, GA (US); JAMES D. KRING, Opelika, AL (US); Jonathan Whitten, Fortson, GA (US); Sachin Mahurkar, Columbus, GA (US); Thomas Kessler, Columbus, GA (US)

(21) Appl. No.: 18/675,986

(22) Filed: May 28, 2024

Related U.S. Application Data
(60) Provisional application No. 63/468,939, filed on May 25, 2023.

(51) Int. Cl. A47J 37/07; F24B 5/02; F24B 13/04

(52) U.S. Cl. CPC A47J 37/0704; A47J 37/0754; F24B 5/023; F24B 13/04

(57) ABSTRACT

A cooking grill has a cooking chamber containing a cooking grate, a solid fuel fire pit beneath the cooking chamber, a fire chimney interposing the fire pit and the cooking chamber, a fuel hopper attached to a fuel chute directing solid fuel from the hopper into the firepit by gravity, and a fan directing combustion air into the fire pit.

### CROSS-REFERENCE TO RELATED CASES

This application claims the benefit of U.S. provisional patent application Ser. No. 63/468,939, filed on May 25, 2023, and incorporates such provisional application by reference into this disclosure as if fully set out at this point.

### FIELD OF THE INVENTION

This disclosure relates to smokers for cooking in general and, more particularly, to gravity fed charcoal smokers.

### BACKGROUND OF THE INVENTION

One of the main shortcomings of smoker systems having a firebox adjacent to a cooking chamber is significant loss of efficiency due to heat loss from the firebox via radiation, and via upward draft. Radiation from a solid surface is transferred in all directions including upward. Combustion products and heated gases will also travel vertically upwards due to buoyant forces. This combination results in significant loss of energy.

In prior systems where fuel is fed into an adjacent or offset fire box, combustion products are forced to travel from the offset firebox into an adjacent cooking chamber. Here the rate of energy loss is even higher due to higher temperature of the burning fuel resulting from forced air. This significant lack of efficiency requires a large amount of fuel to be consumed for a regular cook.

What is needed is a system and method that addresses these and other issues.

### SUMMARY OF THE INVENTION

The invention of the present disclosure, in one aspect thereof, comprises a cooking grill having a cooking chamber containing a cooking grate, a solid fuel fire pit beneath the cooking chamber, a fire chimney interposing the fire pit and the cooking chamber, a fuel hopper attached to a fuel chute directing solid fuel from the hopper into the firepit by gravity, and a fan directing combustion air into the fire pit.

Some embodiments further comprise a heat baffle in the cooking chamber interposing the fire chimney and the cooking grate. The heat baffle may comprise a peaked top and a pair of spaced apart downward projecting wedge shaped sidewalls. In some cases, a narrow end of the wedge shaped sidewalls are proximate the fire chimney. The wedge shaped sidewalls may be perforated. The peaked top of the heat baffle may comprise a double walled section. The double walled section of the peaked top of the heat baffle may be situated over the fire chimney.

In some cases, the hopper is laterally beside the cooking chamber and horizontally offset from the fire pit. The fuel chute may direct solid fuel downward into the fire pit at a slope of at least 30 degrees.

The fire pit may connect to the fire chimney on a first side, and receive air from the fan on a second, opposite side. The fire pit may comprise a lower grate sized to allow ashes to pass through but to retain solid fuel. In some embodiments, the fire pit further comprises a fire pit core nested in an air diverter, the air diverter directing air from the fan into the fire pit core as primary air from a first direction toward the fan, and directing air from the fan into the fire pit core as secondary air from a direction spaced apart from the fan.

A damper may interpose the fire pit and the fan. A damper may be proximate a top of the fire chimney.

The invention of the present disclosure, in another aspect thereof, comprises a cooking grill having a cooking chamber containing a cooking grate, a hopper external to the cooking chamber, a fire pit below the cooking chamber, a fuel chute leading downward from the hopper to the fire pit to direct solid fuel from the hopper to the fire pit under gravity, a fire chimney leading upward from the fire pit to the cooking chamber and fluidly connecting the fire pit and the cooking chamber, and a fan directing combustion air into the fire pit.

In some embodiments, the fire pit further comprises a fire pit core nested in an air diverter, the air diverter receiving air from the fan and dispersing it into the fire pit core from a first direction as primary air and from a second direction as secondary air. The first direction may be a direction of the fan relative to the fire pit core. In some cases, the fire pit connects to the fire chimney on a side opposite from the fan.

Some embodiments include a shutter damper interposing the fire pit core and the fan. Some embodiment include a manually operable damper proximate a top of the fire chimney to selectively impede flow of gases from the chimney.

### BRIEF DESCRIPTION OF THE DRAWINGS

FIG. 1 is a front elevational view of one embodiment of a gravity fed smoker/grill according to the present disclosure.

FIG. 2 is a front cutaway view of the device of FIG. 1 with basic fuel/combustion flow labelled.

FIG. 3 is a perspective view of a firepit for a gravity fed charcoal smoker/grill according to the present disclosure.

FIG. 4A is a perspective view of an air diverter system according to the present disclosure.

FIG. 4B is a horizontal cutaway perspective view of the air diverter system of FIG. 4A.

FIG. 5A is a perspective view of a firepit core according to the present disclosure.

FIG. 5B is a vertical cutaway perspective view of the firepit core according to the present disclosure.

FIG. 6A is perspective view of an ash pan and fire starter according to the present disclosure.

FIG. 6B is another perspective view of the ash pan and fire starter of FIG. 6A with the ash pan in phantom.

FIG. 7A is a perspective view of a fire chimney with an adjacent fire pit shown in phantom.

FIG. 7B is a perspective view of the fire chimney of FIG. 7A rotated to show interior structure.

FIG. 8 is a closeup cutaway interior perspective view of a gravity fed charcoal smoker/grill according to the present disclosure.

FIG. 9A provides a cutaway view of a cooking chamber with heat baffle according to the present disclosure.

FIG. 9B is an inferior perspective view of the heat baffle of FIG. 9A.

FIG. 9C is a superior perspective view of the heat baffle of FIG. 9A.

FIG. 10 is a superior perspective view of another embodiment of a heat baffle according to the present disclosure.

FIG. 11 is superior perspective view of a further embodiment of a heat baffle according to the present disclosure.

FIG. 12 is a simplified schematic diagram of a control system for a gravity fed smoker/grill according to the present disclosure.

### DETAILED DESCRIPTION OF THE PREFERRED EMBODIMENTS

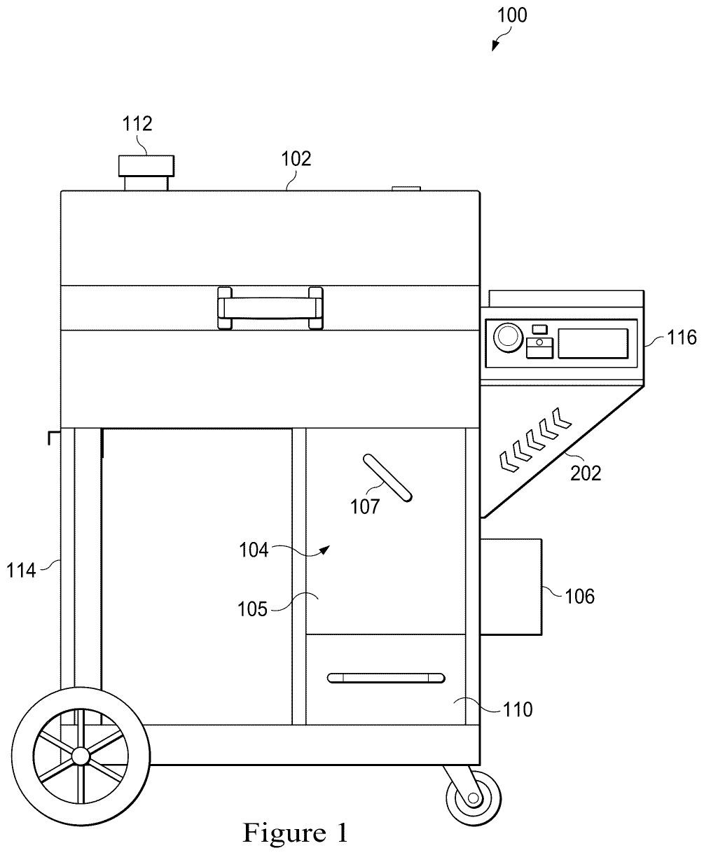

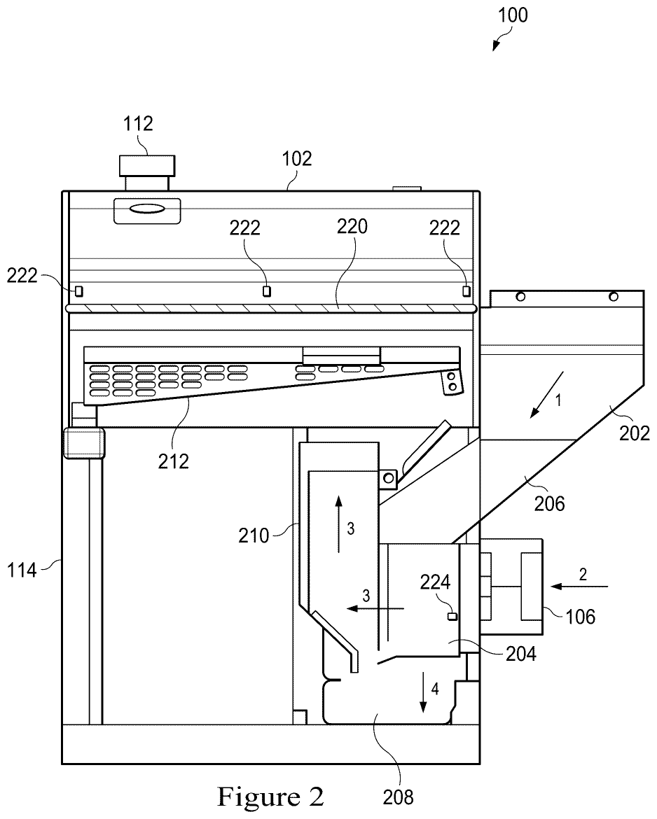

Referring now to FIG. 1, a front elevational view of a gravity fed charcoal smoker/grill 100 according to the present disclosure is shown. The device 100 will be referred to as a smoker, a grill, or a smoker/grill in the present disclosure but it should be understood that the device 100 may be capable of both grilling and smoking operations regardless of how it is specifically named. Referring also to FIG. 2 is a front cutaway view of the device 100 of FIG. 1 with basic fuel/combustion flow labelled with arrows 1, 2, 3, and 4.

The smoker 100 may comprise a cooking chamber 102 having a smokestack 112 (or multiple smokestacks). Internal to the cooking chamber is a cooking grate 220. Various doors and openings may provide access to an interior of the cooking chamber 102 to perform cooking operations. Any opening known to the art (e.g., hinged openings, roll away openings) may be employed.

Below the cooking chamber 102 is a combustion and heating chamber 104. The cooking chamber 102 and combustion and heating chamber 104 may be supported by a cart 114 or other structure. A door 105 may be provided for accessing an interior of the heating and combustion chamber 104. An ash drawer 110 may also be accessible from outside the device 100.

An air supply fan 106 may provide forced air to the grill 100. In some embodiments the air supply fan 106 provides forced combustion air into a firepit 204. Combustion products and heat exiting the firepit 204 may be directed to or vented to the cooking chamber 102 via a fire chimney 210. A heat baffle 212 may be provided within the cooking chamber 102 below the cooking grate 220 to ensure even distribution of heat, smoke, and combustion products to the cooking grate 220 and within the cooking chamber 102. One or more temperature sensors 222 may be provided at various locations near or around the cooking grate 220 and provide temperature readings to a control system 116.

An external hopper 202 may provide solid fuel that travels into the firepit 204 via a chute 206. The solid fuel used by the grill 100 may comprise various forms of charcoal (e.g., charcoal briquettes or lump charcoal) or other combustibles. In various embodiments, the minimum slope of the chute 206 for proper flow of solid fuel is 30°. However, steeper slopes may improve the performance of system by increasing the pressure on the solid fuel in the firepit 204. Temperature of or within the firepit 204 may be monitored by the control system 116 using a temperature sensor 224.

Below the firepit 204 is an ash pan 208, which may be located in, or be a part of, the ash drawer 110.

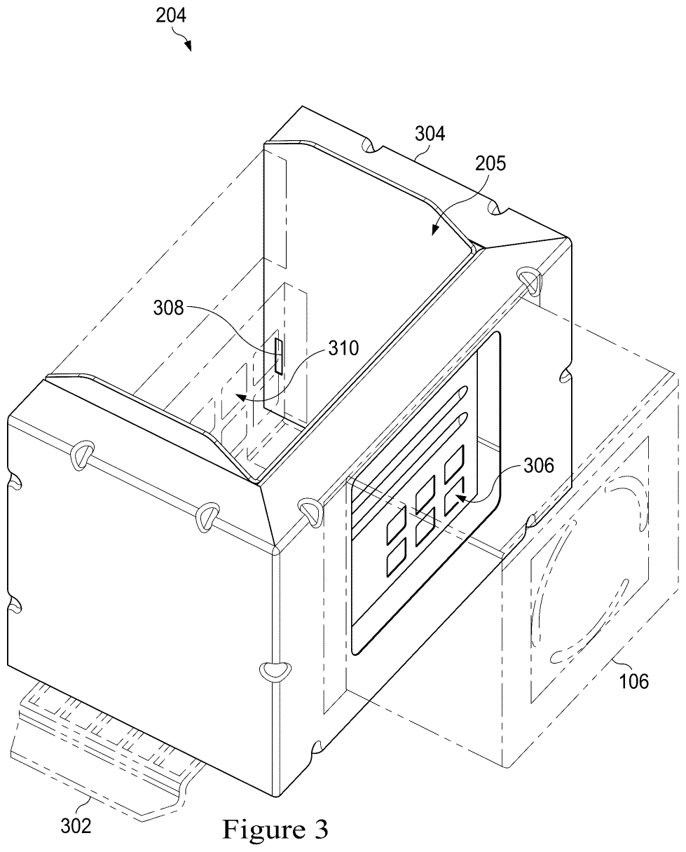

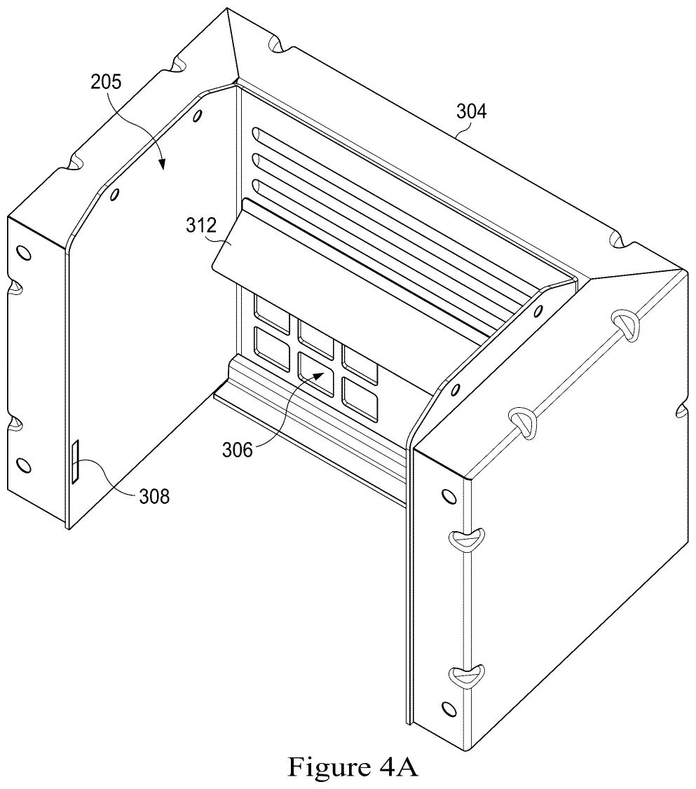

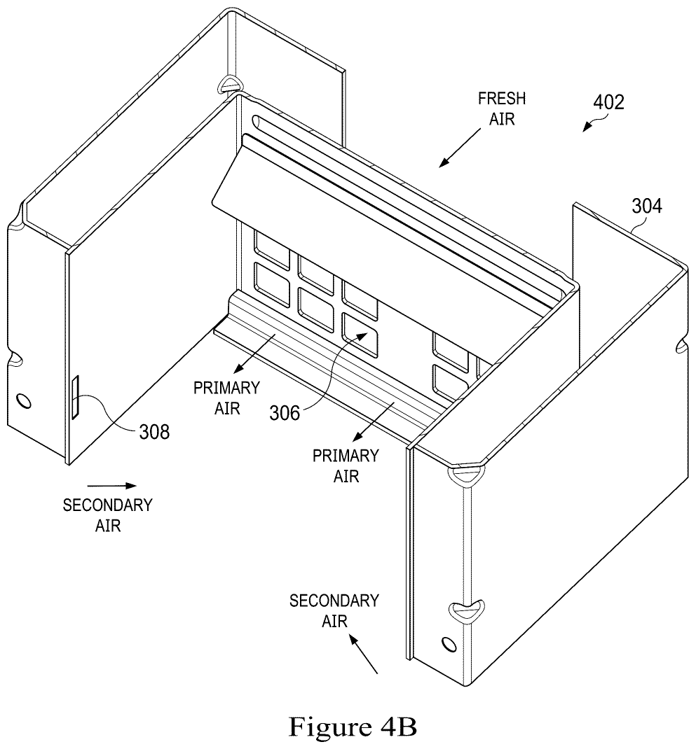

Referring now also to FIG. 3 a perspective view of the firepit 204 is shown. FIG. 4A provides a perspective view of an air diverter system 304 that may be said to form part of the firepit 204, or can be considered a separate system. A cutaway perspective view of the air diverter 304 is provided in FIG. 4B. The supply air fan 106 (which may be controlled thermostatically) provides a proper amount of air into the firepit 204 and the air diverter 304. A majority of the air by the fan 106 mostly (measured, e.g., by volume) may enter a firepit core 205 via primary air outlet 306 proximate the fan 106.

The primary air outlet 306 may comprise a plate forming a back wall of the firepit core 205 and defining a number of openings or perforations. A center or other portion of the primary air outlet 306 may define an area devoid of perforations. This arrangement tends to force some airflow laterally away from the outlet 306 and into the air diverter 304. The primary air outlet 306 may also have louvres or vanes directing air downward or in another appropriate direction at it enters the firepit core 205.

The air diverter 304 may comprise a duct or conduit surrounding the firepit core 205 to convey air to one or more secondary air outlets 308. These may be on opposite sides of the firepit core 205 and may be spaced apart from the primary air outlet 306. The secondary air outlets 308 may be located to direct air relatively low within the firepit core 205, possibly near a fire grate 302 supporting fuel for combustion. The secondary air outlets 308 may or may not have any particular external vanes or louvres.

In operation, some of the air provided by the fan 106 travels around the firepit core 205 to mix into with the firepit core 205 at a firepit outlet 310 as secondary air (via secondary air outlets 308). This improves the efficiency of combustion when the system is used as a grill. It also increases the operating temperature range, stabilizes the temperature, and smooths any overshoots.

This configuration described above combined with a sloped tab 312 over and angled away from the air outlet 306 create air flow on all sides of solid fuel inside the firepit 204 providing for uniform smoldering/combustion of the fuel. Without these structures, smoldering and combustion would be only in the middle of the firepit core 205.

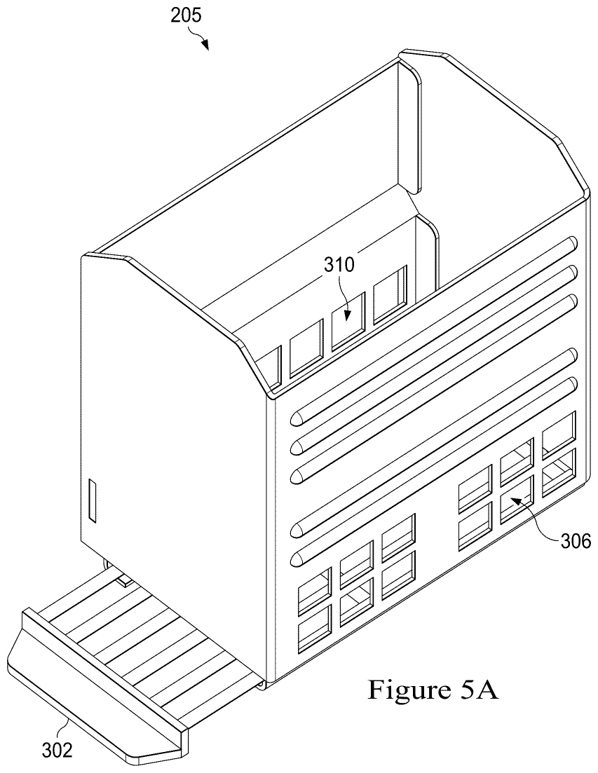

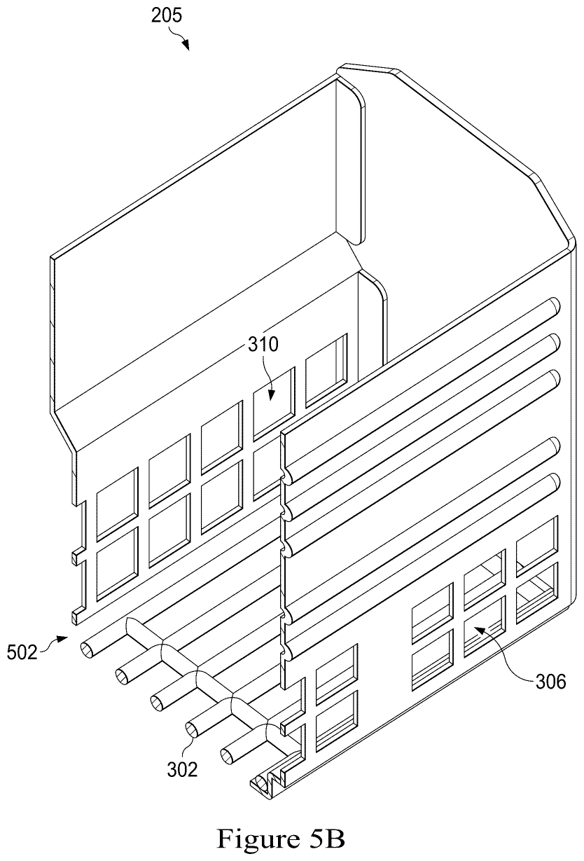

Referring now to FIG. 5A a perspective view of the firepit core 205 according to the present disclosure is shown. FIG. 5B illustrates the firepit core 205 in perspective with a proximal portion cutaway. The fire grate 302 may be removable allowing for deep cleaning of the system. The width of the openings on the firepit core 205 generally, and the fire grate 302 specifically, are optimized to prevent the ash buildup in the system and prevent burning solid fuels from prematurely falling through the firepit core 205. The opening sizes also need to allow for the outflow of the combustion products with minimum pressure drop in the system. For burning charcoal briquettes, it has been found that the width should be between about 12 to about 17 mm for the bottom openings (e.g., fire grate 302) and about 13 to about 27 mm for the side openings (e.g., primary air outlet 306 and/or firepit outlet 310).

As the combustion characteristics of charcoal and wood pellets are different, the control system 116 may differentiate between types of fuel and adjust the air supply cycles and the ignition cycle accordingly. The removable fire grate 302 may also account for the change in the fuel. While the width of openings in the fire grate 302 may range between 12 to 17 mm for charcoal, they may range between 5 to 6 mm for the wood pellets. Therefore, the fire grate 302 may be exchanged for another with a differing openings. In other embodiments, the fire grate 302 is adjustable.

A waterfall opening 502 to allow ash to escape between the fire grate 302 and the firepit exhaust 310 allows for ash to flow through rather than building up and blocking the flow of the combustion products. As the combustion products leave the firepit core 205, the weight of fresh fuel pushes the ash downwards and a supply of fresh fuel continues.

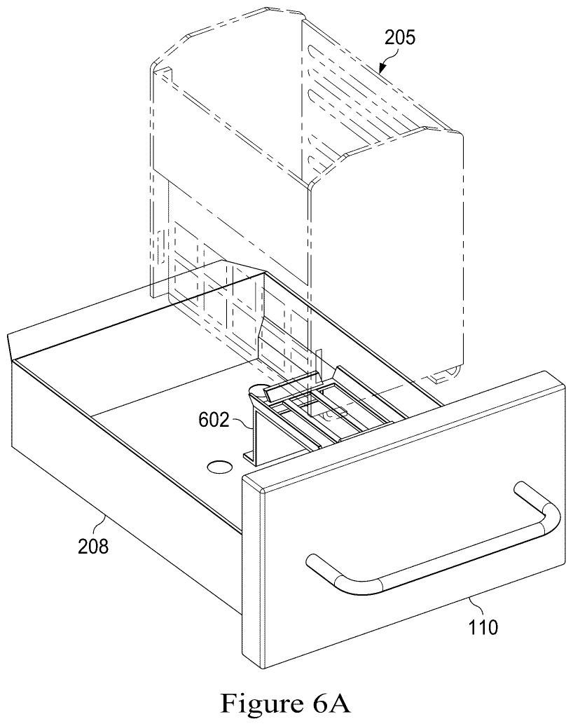

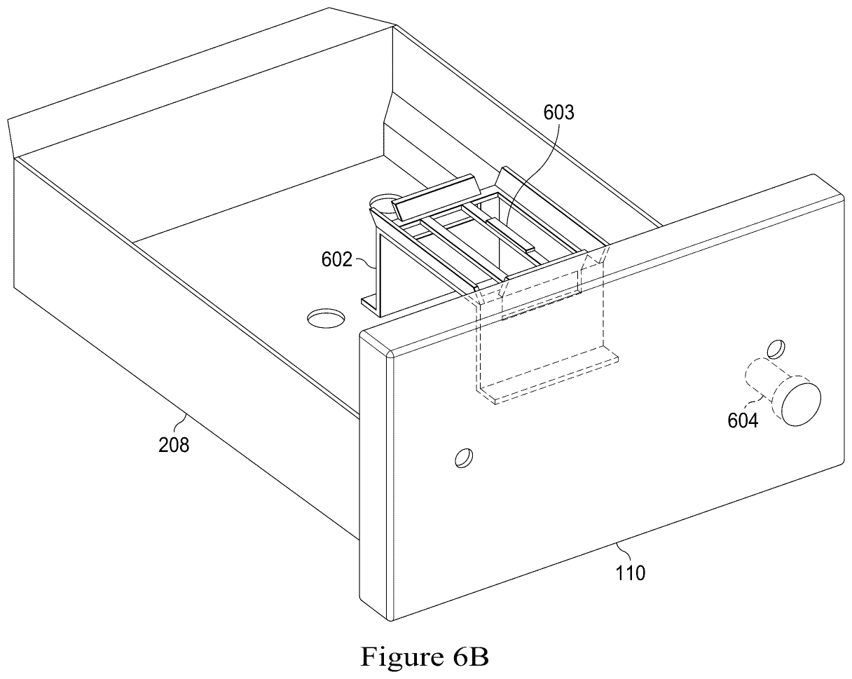

Referring now to FIG. 6A, a perspective view of an ash pan 208 with fire starter platform or tray 602 is shown. FIG. 6A also illustrates a relative placement of the firepit core 205 with respect to the tray 602 during operation. FIG. 6B is another perspective view of the ash pan ash pan 208 with the ash pan 208 a front of the drawer 110 shown in phantom. FIG. 6B highlights the fire starter tray 602 and a possible location of a drawer sensor 604. The fire starter 602 tray may comprise or be attached to an ignitor 603 for igniting solid fuel. In some embodiments, the ignitor 603 comprises a resistive heating element.

The drawer sensor 604 may provide confirmation that the drawer 110 is properly closed prior to operation of the grill 100. Indication of the drawer 110 closure state may be communicated to the control system 116, for example. In some cases, the control system 116 does not allow operation of the grill 100 when the drawer 110 is not closed.

As shown in FIGS. 6A and 6B, the drawer 110 comprises the ash pan 208. However, the ash pan 208 could be a separate container within the drawer 110, or detachable from a front of the drawer 110. The fire starter tray 602 may be built into the ash pan 208. The fire starter tray 602 may also be removed independently from the fire grate 302. It could also have its own separate door. The fire starter tray 602 allows for easier start of the fire as a user can start the fire on the tray 602 in the open air (without air restrictions inside the system, especially when the fan 106 is off) and then insert it into the system under the fire grate 302. The present system also allows for easy restart of the fire with no need to drain and refill the fuel above the fire grate 302.

In another embodiment, the fire can be started via heat generated by a resistive heating element. The electric heating element can be placed adjacent to the fire grate 302 (either above it or below it). A heating element may be integrated into the fire grate 302 or the firepit 204 itself. A non-resistive electric source of ignition, such as spark ignition may be used. In some embodiments, a propane or natural gas burner could be used in conjunction with a spark ignition to ignite the charcoal system. The control system 116 has the capability to automatically control an ignition system utilized using circuitry and/or microelectronics as are known to the art.

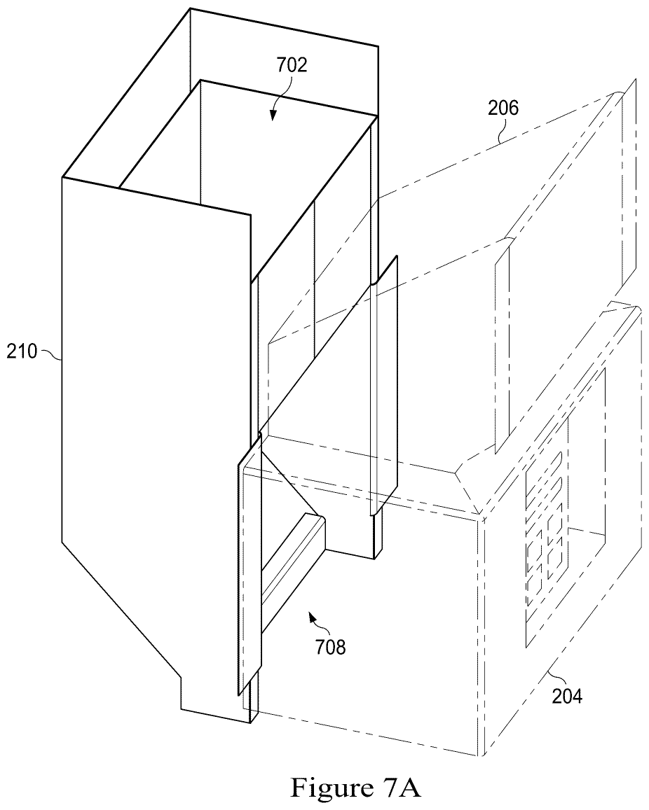

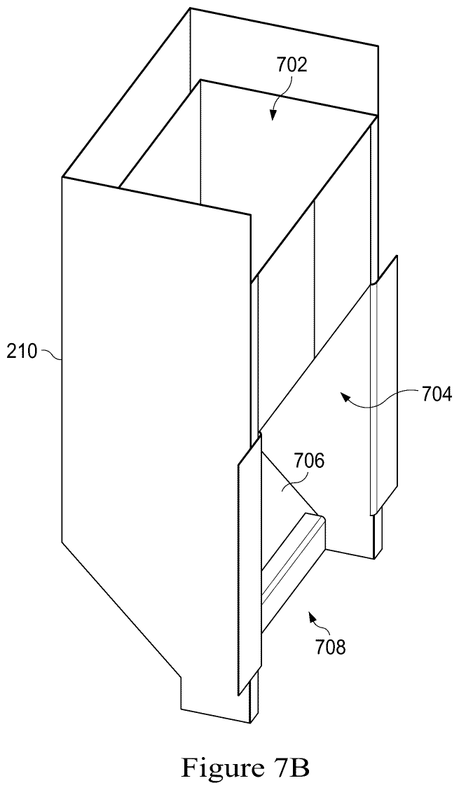

Referring now to FIG. 7A, a perspective view of the fire chimney 210 and firepit 204 are shown. FIG. 7A illustrates the fire chimney 210 in relative position next to the firepit 204 (in phantom) and the chute 206 (in phantom). FIG. 7B provides a perspective view of the fire chimney 210 without the firepit 204 and chute 206. Here, a port 704 to the firepit outlet 310 is visible. Adjacent to the port 704 may be a sloped wall 706 terminating at a gap 708 (FIG. 1) interposing the sloped wall 706 and fire pit 204 to allow ash to escape.

A top opening 702 interfaces to deliver heat, smoke, and other combustion products to the cooking chamber 102 (FIGS. 1-2). The fire chimney 210 may comprise a double-wall narrow channel that directs the hot gas into the cooking chamber 102. This arrangement increases the system's thermal efficiency, while keeping the temperature of the exterior of the chimney 210 low. A double-walled design also allows the system to heat up fast. In other embodiments, the fire chimney 210 is of a single-wall design, and may utilize other temperature controlling materials such as insulation and ceramics.

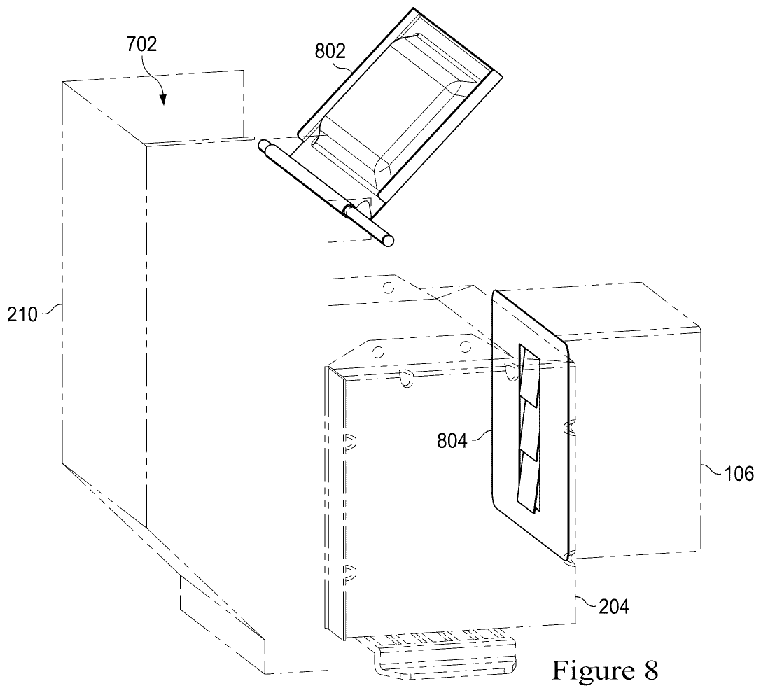

Referring now to FIG. 8, a closeup cutaway interior perspective view of a gravity fed charcoal smoker/grill according to the present disclosure is shown. FIG. 8 illustrates the chimney 210, the firepit 204, and the fan 106 in phantom, and in relative positions with respect to one another. Systems of the present disclosure allows for having air and gas dampers that can reduce the external heat loss during the operation of the unit and allow for choking off the fire after the cooking is completed to preserve fuel.

FIG. 8 depicts an exemplary snuff out system based on two dampers. An air damper 804 may be placed downstream of the air supply fan 106. The damper 804 may comprise a flap damper that remains closed when the fan 106 is stopped, and opens due to air pressure when the fan 106 is running. At the end of each cook, this damper 804 may be automatically closed.

A second damper 802 may be placed at the exit 702 of the fire chimney 210. During the cooking process, the damper 802 may be open, with an upward slope directing combustion products into the cooking chamber 102. At the end of the cook, the damper 802 may be manually closed.

In other embodiments, on or both dampers 802, 804 may be opened and closed by the control system 116. Solenoids, stepper motors, or other power devices as known in the art may be used to this end. Dampers 802, 804 may be controlled manually in some embodiments. The damper 802 may be operable via a handle 107 external to the damper. The damper 804 may comprise a one way damper or shutter that opens under air pressure or flow from the fan 106 and then closes automatically when the fan 106 is not operating.

The combination of closed dampers deprives the fuel inside the firepit 204 from fresh air and chokes the fire. Additionally, the combination of air/gas dampers 802, 804 (at the fan 106 and fire chimney 210) and the air diverter 304 (providing both primary and secondary air) may eliminate the need for adjusting the exhaust 112 leaving the cooking chamber 102.

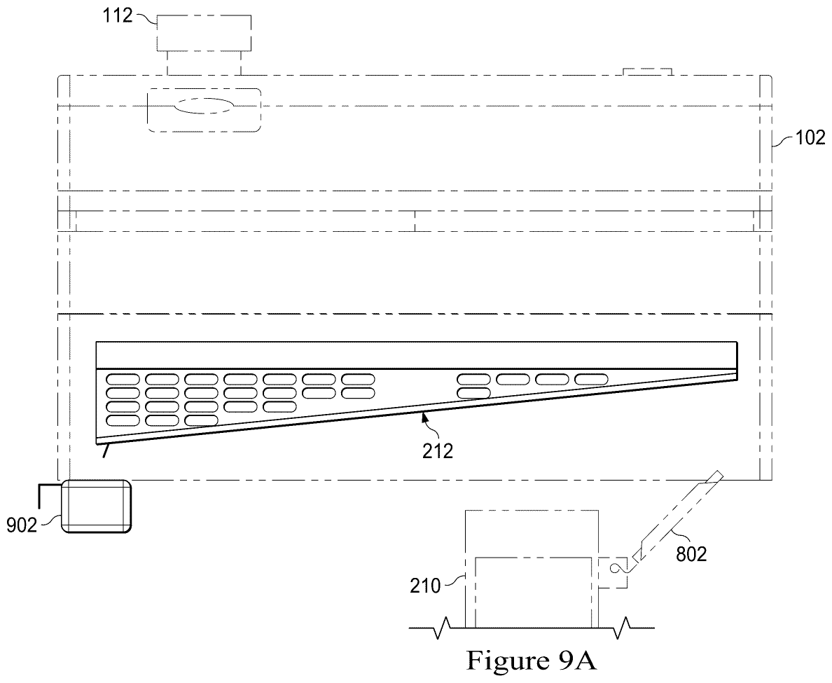

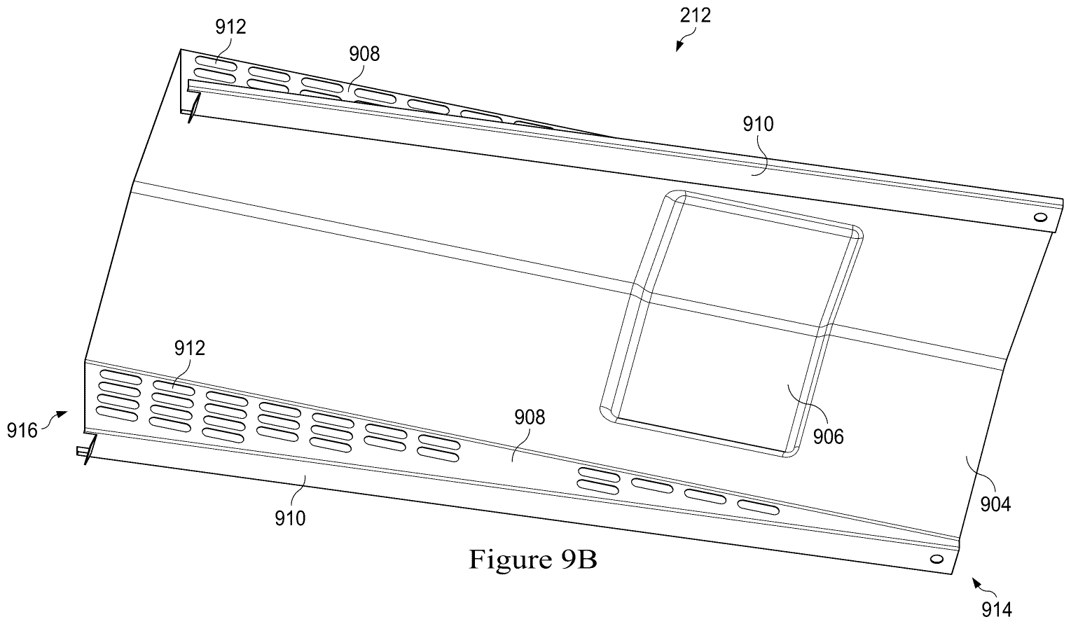

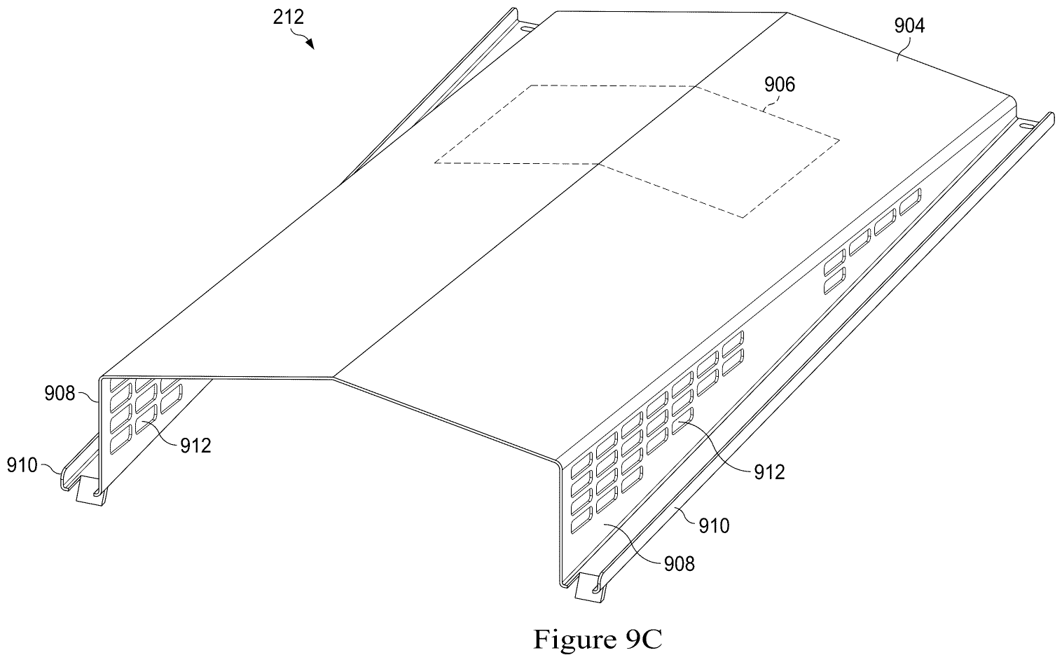

Referring now to FIG. 9A, a cutaway view of the cooking chamber 102 with heat baffle 212 according to the present disclosure is shown. FIG. 9A provides one possible position for the baffle within the cooking chamber 102. An inferior perspective view of the heat baffle 212 is provided by FIG. 9B. A superior perspective view of the heat baffle 212 is provided in FIG. 9C. In some embodiments, the baffle 212 comprises a top 904 that may be sloped or have a peak running longitudinally to shed oil and cooking debris. Side walls 908 may descend from the top 904 and may be wedge shaped or somewhat triangular as shown to control heat/smoke flow. A narrow end 914 of the wedge shape may be nearer or proximate the fire chimney 210 while a broader end 916 is further away. This may allow for control over heat and gas distribution in the cooking chamber 102. Optional side perforations 912 in the walls 908 may also allow for further heat/smoke distribution control. Sloped side channels 910 direct the food grease into a grease collection cup 902 at the side or end. The side channel may slope from the narrow end 914 to the broader end 916 of walls 908. A cavity created by a double wall portion 906 of the top 904 prevents an overheated spot at the cooking grate by managing the direct radiation and the hot plume leaving the fire chimney 210.

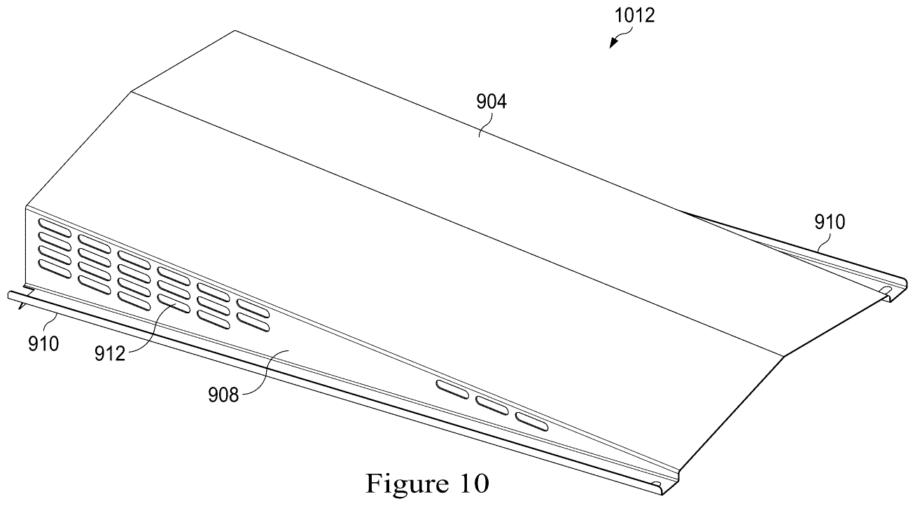

Referring now to FIG. 10 is a superior perspective view of another embodiment of a heat baffle 1012 according to the present disclosure is shown. In some embodiments, heat baffle 1012 is used in place of heat baffle 212 described above. The heat baffle 1012 differs from the heat baffle 212 in that no double wall portion 906 is provided. Such a configuration may result in different cooking characteristics at different locations on the cooking grate. In other embodiments, the geometry of the baffle 1012 is such that even heating is provided at the cooking grate in the absence of any double walled portion.

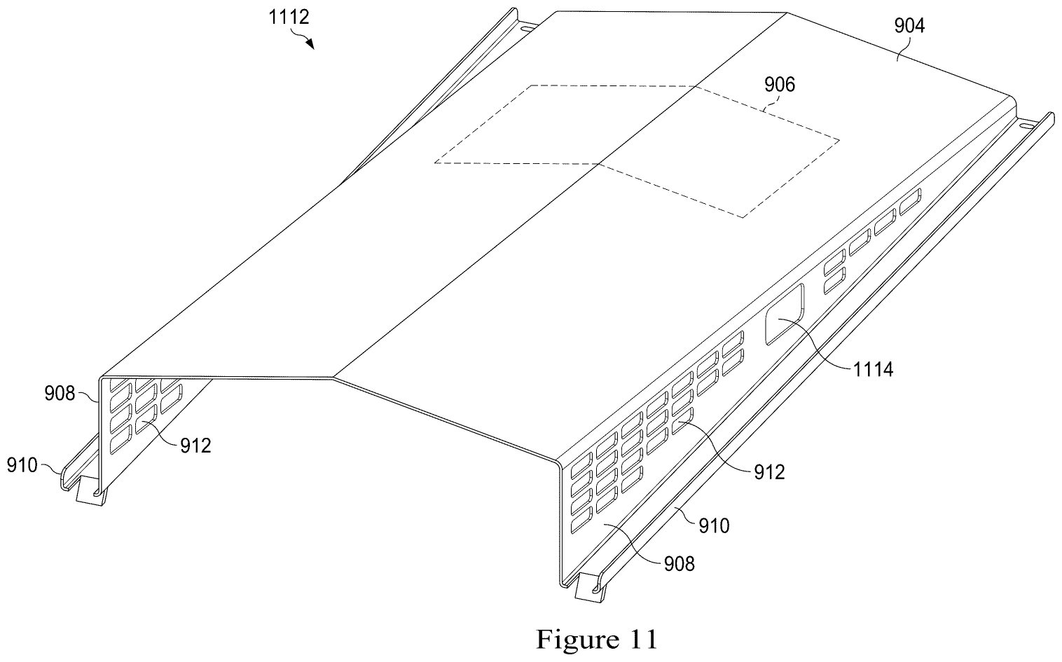

Referring now to FIG. 11, a superior perspective view of a further embodiment of a heat baffle 1112 according to aspects of the present disclosure is shown. In some embodiments, the heat baffle 1112 is used in place of the heat baffle 212 or the heat baffle 1012 described above. The heat baffle 1112 differs from the heat baffle 212 in one or more relatively larger openings 1114 may be provided in one or both walls 908 in addition to perforations 912. The larger openings 1114 may be provided to alter combustion product and heat flow through the walls 908 and/or to provide a lifting point or handle for the heat baffle 1112.

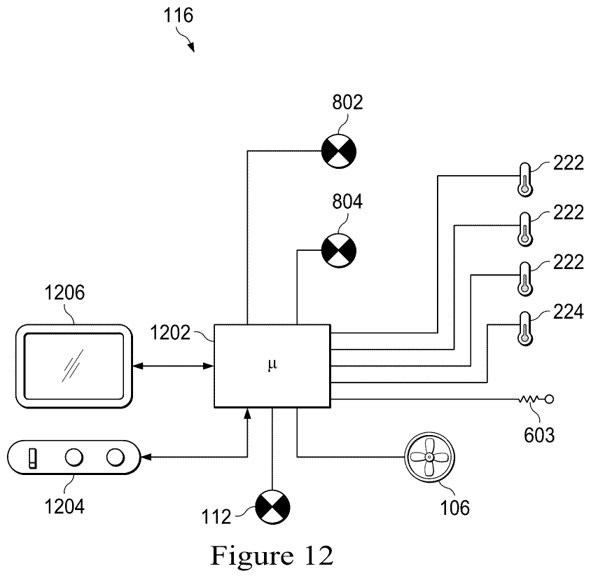

Referring now to FIG. 12, a simplified schematic diagram of the control system 116 is shown. The control system 116 may be based on a silicon controller 1202. The controller 1202 may comprise a microcontroller, a microprocessor, a system on a chip, a field programmable gate array (FPGA), an application specific integrated circuit (ASIC)). The controller 1202 may be capable of executing control and command functions according to the operations described herein. In some cases, the controller 1202 communicates with an application on a user's device (e.g., a phone) for receipt of commands and/or display of data.

The controller 1202 may receive data from the temperature sensors 222, 224 that may be used to thermostatically control the fan 106 and/or the ignitor 603. Damper valves 802, 804 may also be controlled by controller 1202 in accordance with user input or a control program.

A control panel 1204 may be used to input operational commands or parameters to the controller. A display screen 1206 may display current temperatures, programs, etc. In some embodiments the display screen 1206 is touch sensitive to provide commands as well. In some embodiments, separate indicator lights, dials, etc. are used in addition to, or instead of, the display screen 1206.

During operation of the grill 100, the control system 116 may utilize a proportional-integral-derivative (PID) controller or other control mechanisms or devices as known in the art to implement a desired control method. Such PID or other feedback control system may use temperature value(s) from one or multiple sensors (e.g., 222, 224) to control the speed of the fan 106 to regulate the temperature. Damper valves 802, 804 and the ignitor 106 may also be utilized to achieve desired temperatures and other operation. In some embodiments smoke stacks (such as the smoke stack 112 and/or others) may also be controlled manually or via the controller 1202 (e.g., utilizing motors, solenoids, etc.) to alter flow rates of smoke, heat, and other combustion products.

As the combustion characteristics of charcoal and wood pellets are different, the control system 116 may differentiate between types of fuel and adjust the air supply cycles and the ignition cycle accordingly. The removable fire grate 302 may also account for the change in the fuel. While the width of openings in the fire grate 302 may range between 12 to 17 mm for charcoal, they may range between 5 to 6 mm for the wood pellets. Therefore, the fire grate 302 may be exchanged for another with a differing openings. In other embodiments, the fire grate 302 is adjustable.

Referring back again to FIG. 2, During use, fuel is provided by a user into the hopper 202 and flows via the chute 206 under gravity into the fire pit 204 (e.g., arrow 1). No powered conveyance means such as augers or belts are utilized or needed. As the stack of fuel from the hopper 202 and chute 206 is consumed in the fire pit 204, it turns to ash and falls through to ash pan 208 as shown by arrow 4. As this occurs gravity pulls fresh charcoal or other solid fuel downwards into the firebox 204.

Combustion air entering the fan 106 (e.g., Arrow 2) may be forced into the fire pit 204. With the fuel pathway being closed or substantially so, burning gases and combustion products are forced out of the fire pit 204 and into and through the fire chimney (Arrows 3). However, it should be understood that, even without forced air from the fan 106, combustion products from the fire pit 204 will rise through the fire chimney 210 to the cooking chamber 102. This is because heated and expanding gases naturally rise, and the fire chimney 210 leads from the fire pit 204 upward to the cooking chamber 102. Additionally, fuel in the chute 206 and/or hopper 202, a closed hopper or hoper lid, and/or a closed damper 804 tend to impede gas flow out of the fire pit 204 except through the fire chimney 210.

The fire pit 204 may be considered a cuboid (see, e.g., FIGS. 2-3) with primary combustion air entering one face, while combustion gases exit the opposite face. Side faces may be proved with secondary combustion air as described above. A top of the cuboid is provided fuel from the chute 206 while ashes exit a bottom face.

The over all combustion and cooking process may be controlled by adjustment of damper 802 (FIG. 8) which controls flow rate of gases out of the fire chimney 210 and into the cooking chamber 102. Flow of exhaust gases from the cooking chamber 102 may be controlled or adjusted via the smoke stack 112. Control may also be provided by the intermittent or variable operational speed of fan 106. Damper 804 (FIG. 8) may close to prevent escape of combustion gases back through the fan, but may open automatically as the fan 106 operates. In other embodiments, an adjustable damper may be used in place of damper 804 allowing additional control options. As noted above, adjustment of dampers and smoke stacks may occur manually, but may also be controlled by stepper motors, solenoids, or other electronically controlled devices as known to the art by the control system 116.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)—(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking grill comprising:
a cooking chamber containing a cooking grate;
a solid fuel fire pit beneath the cooking chamber;
a fire chimney interposing the fire pit and the cooking chamber;
a fuel hopper attached to a fuel chute directing solid fuel from the hopper into the firepit by gravity; and
a fan directing combustion air into the fire pit.

2. The cooking grill of claim 1, further comprising a heat baffle in the cooking chamber interposing the fire chimney and the cooking grate.

3. The cooking grill of claim 2, wherein the heat baffle comprises a peaked top and a pair of spaced apart downward projecting wedge shaped sidewalls.

4. The cooking grill of claim 4, wherein a narrow end of the wedge shaped sidewalls are proximate the fire chimney.

5. The cooking grill of claim 4, wherein the wedge shaped sidewalls are perforated.

6. The cooking grill of claim 5, wherein the peaked top of the heat baffle comprises a double walled section.

7. The cooking grill of claim 6, wherein the double walled section of the peaked top of the heat baffle is situated over the fire chimney.

8. The cooking grill of claim 1, wherein the hopper is laterally beside the cooking chamber and horizontally offset from the fire pit.

9. The cooking grill of claim 8, wherein the fuel chute directs solid fuel downward into the fire pit at a slope of at least 30 degrees.

10. The cooking grill of claim 1, wherein the fire pit connects to the fire chimney on a first side and receives air from the fan on a second, opposite side.

11. The cooking grill of claim 10, wherein the fire pit comprises a lower grate sized to allow ashes to pass through but to retain solid fuel.

12. The cooking grill of claim 10, wherein the fire pit further comprises a fire pit core nested in an air diverter, the air diverter directing air from the fan into the fire pit core as primary air from a first direction toward the fan, and directing air from the fan into the fire pit core as secondary air from a direction spaced apart from the fan.

13. The cooking grill of claim 10, further comprising a damper interposing the fire pit and the fan.

14. The cooking grill of claim 10, further comprising a damper proximate a top of the fire chimney.

15. A cooking grill comprising:
a cooking chamber containing a cooking grate;
a hopper external to the cooking chamber;
a fire pit below the cooking chamber;
a fuel chute leading downward from the hopper to the fire pit to direct solid fuel from the hopper to the fire pit under gravity;
a fire chimney leading upward from the fire pit to the cooking chamber and fluidly connecting the fire pit and the cooking chamber; and
a fan directing combustion air into the fire pit.

16. The cooking grill of claim 15, wherein the fire pit further comprises a fire pit core nested in an air diverter, the air diverter receiving air from the fan and dispersing it into the fire pit core from a first direction as primary air and from a second direction as secondary air.

17. The cooking grill of claim 16, wherein the first direction is a direction of the fan relative to the fire pit core.

18. The cooking grill of claim 17, wherein the fire pit connects to the fire chimney on a side opposite from the fan.

19. The cooking grill of claim 18, further comprising a shutter damper interposing the fire pit core and the fan.

20. The cooking grill of claim 19, further comprising a manually operable damper proximate a top of the fire chimney to selectively impede flow of gases from the chimney.
